(19) United States
(12) Patent Application Publication
(10) Pub. No.: US 2019/0005577 A1
(43) Pub. Date: Jan. 3, 2019

(54) INFORMATION PROCESSING APPARATUS, INFORMATION PROCESSING METHOD, AND COMPUTER PROGRAM

(71) Applicant: NOMURA RESEARCH INSTITUTE. LTD., Tokyo (JP)

(72) Inventor: Takaharu HOSHINO, Tokyo (JP)

(73) Assignee: NOMURA RESEARCH INSTITUTE, LTD., Tokyo (JP)

(21) Appl. No.: 16/104,643

(22) Filed: Aug. 17, 2018

Related U.S. Application Data
(63) Continuation of application No. PCT/JP2017/005321, filed on Feb. 14, 2017.
Application No. PCT/JP2017/005321 is a continuation of application No. PCT/JP2016/054702, filed on Feb. 18, 2016.

(51) Int. Cl. G06Q 40/02; H04L 29/06

(52) U.S. Cl. CPC G06Q 40/025; H04L 63/0414

(57) ABSTRACT

A business support apparatus that supports a financial institution in its business operations acquires, from an individual attribute information source, assets information representing assets held by a subject to be analyzed, outside the financial institution. Based on the assets information acquired from the individual attribute information source, the business support apparatus determines a score of the subject to be analyzed, for determining details of business operations of the financial institution for the subject to be analyzed. Based on the determined score, the business support apparatus generates information for supporting the financial institution in its business operations for the subject to be analyzed.

### BACKGROUND

### Technical Field

The present invention relates to data processing technology, and more particularly, to information processing technology for supporting a financial institution in its business operations.

### Related Art

A technique for efficiently implementing asset liability management (ALM) for the purpose of sound management of banks has been proposed (see, for example, JP 2004-303036 A). In addition, a technique for improving the accuracy of assessment of debtor's assets and reducing credit risks of financial institutions has been proposed (see, for example, JP 2003-248754 A).

### SUMMARY

Thus far, interest rates on loans to customers (including individuals and corporate bodies) provided by financial institutions have been determined by factors at the financial institutions (the short-term prime rate, and the like). The present inventors consider that hereafter, it will be important for financial institutions to flexibly adjust interest rates according to the state of assets owned by each customer, in expectation of, for example, diversification of loans and an increase in security assets.

The present invention has been made in view of the above-described problem, and its main object is to provide technology for supporting financial institutions so as to allow them to offer financial services more appropriate to the situations of respective customers.

In order to solve the above-described problem, an information processing apparatus according to one aspect of the present invention is an apparatus that supports a financial institution in business operations thereof, and includes: an acquisition unit configured to acquire assets information representing assets held by a subject to be analyzed, outside the financial institution; a score determination unit configured to determine a score of the subject to be analyzed, for determining details of business operations of the financial institution for the subject to be analyzed, based on the assets information acquired by the acquisition unit; and a support information generation unit configured to generate information for supporting the financial institution in business operations thereof for the subject to be analyzed, based on the score of the subject to be analyzed, determined by the score determination unit.

Another aspect of the present invention is also an information processing apparatus. The apparatus supports a plurality of financial institutions in business operations thereof, and includes: an acquisition unit configured to acquire assets information representing assets held by a first subject that is a subject to be analyzed in a first financial institution, the assets being held outside the first financial institution; a score determination unit configured to determine a score of the first subject for determining details of business operations of the first financial institution for the first subject, based on the assets information of the first subject acquired by the acquisition unit and a parameter predetermined by the first financial institution; and a support information generation unit configured to generate information for supporting the first financial institution in business operations thereof for the first subject, based on the score of the first subject determined by the score determination unit. The acquisition unit further acquires assets information representing assets held by a second subject that is a subject to be analyzed in a second financial institution, the assets being held outside the second financial institution. The score determination unit further determines a score of the second subject for determining details of business operations of the second financial institution for the second subject, based on the assets information of the second subject acquired by the acquisition unit and a parameter predetermined by the second financial institution. The support information generation unit further generates information for supporting the second financial institution in business operations thereof for the second subject, based on the score of the second subject determined by the score determination unit.

Still another aspect of the present invention is an information processing method. The method, which is to be performed by an apparatus that supports a financial institution in business operations thereof, includes: a step of acquiring assets information representing assets held by a subject to be analyzed, outside the financial institution; a step of determining a score of the subject to be analyzed for determining details of business operations of the financial institution for the subject to be analyzed, based on the acquired assets information; and a step of generating information for supporting the financial institution in business operations thereof for the subject to be analyzed, based on the determined score of the subject to be analyzed.

It should be noted that any combinations of the above-described constituent elements and those obtained by converting expressions of the present invention among a system, a computer program, a recording medium storing the computer program, and the like are also effective as aspects of the present invention.

According to the present invention, it is possible to support financial institutions so as to allow them to offer financial services more appropriate to the situations of respective customers.

### BRIEF DESCRIPTION OF DRAWINGS

FIG. 1 is a diagram showing a configuration of an information system according to an embodiment;

FIG. 2 is a block diagram showing a functional configuration of a business support apparatus shown in FIG. 1;

FIGS. 3A and 3B are tables showing an example of a loan to an individual;

FIGS. 4A and 4B are tables showing an example of a loan to the individual; and

FIG. 5 is a diagram showing a configuration of an information system according to a fourth modification.

### DETAILED DESCRIPTION

In an embodiment, there is proposed a business support apparatus (business support apparatus 14 to be described below) for supporting a financial institution in its lending operations for individuals (for example, housing loans). The business support apparatus dynamically calculates both credit lines and lending rates for respective customers (including individuals as potential customers and individuals as targets in promoting lending operations) according to various attribute information of the respective customers. A credit line can be regarded as an allowable amount of loans or as a maximum amount of loans.

Furthermore, currently in Japan, an Individual Number (My Number (registered trademark)) is assigned by public institutions (the government and others) to each citizen. In principle, the Individual Number is an ID number unique to an individual, which will not be changed for a lifetime. From 2016, the Individual Number will be necessary in administrative procedures including social security, tax, disaster countermeasures, and the like. The business support apparatus according to the embodiment uses the Individual Number to collect, from an external device, various attribute information on an individual who is to obtain a loan.

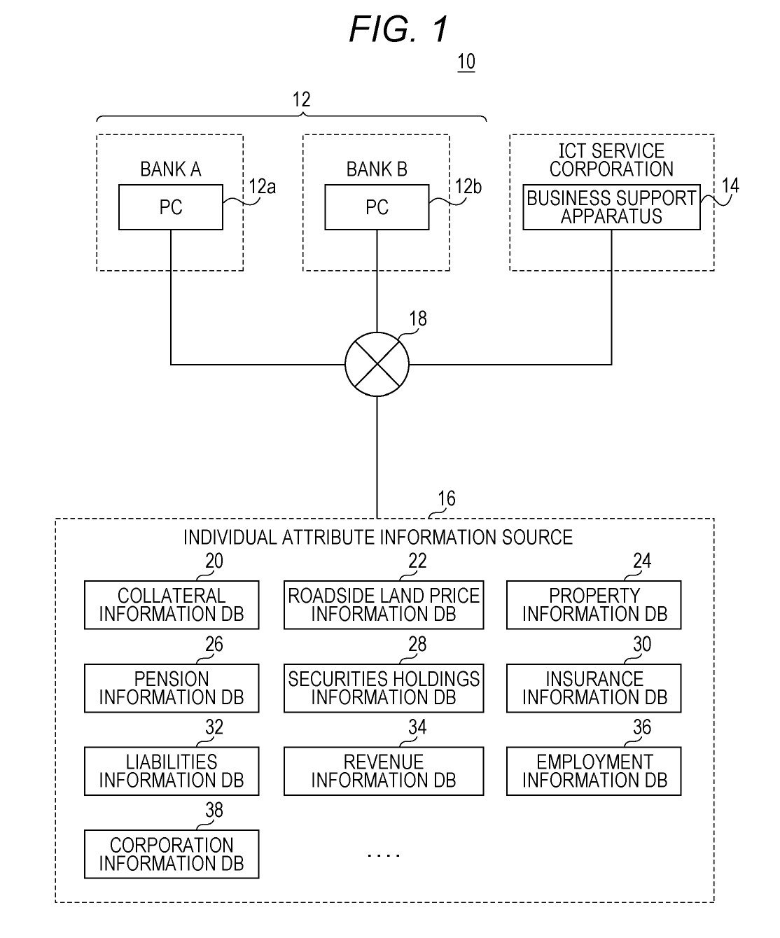

FIG. 1 shows a configuration of an information system 10 according to the embodiment. The information system 10 includes a PC 12a and a PC 12b, which are collectively referred to as a PC 12, the business support apparatus 14, and an individual attribute information source 16. Each apparatus shown in FIG. 1 is connected via a communication network 18 including a LAN, a WAN, the Internet, and a private line. Although not described below, encryption and authentication processing may be performed for maintaining security during communication, according to circumstances.

The PC 12a is installed in a bank A, and operated by a person in charge of loans at the bank A. The PC 12b is installed in a bank B, and operated by a person in charge of loans at the bank B. The PC 12 may be another kind of information terminal such as a tablet terminal and a smartphone.

The individual attribute information source 16 is a collective term for a plurality of database apparatuses (hereinafter referred to as “DB”) for storing various attribute information on individuals as debtors. The individual attribute information source 16 includes a collateral information DB 20, a roadside land price information DB 22, a property information DB 24, a pension information DB 26, a securities holdings information DB 28, an insurance information DB 30, a liabilities information DB 32, a revenue information DB 34, an employment information DB 36, and a corporation information DB 38.

There is no limitation on the place to install each DB included in the individual attribute information source 16. In the embodiment, it is assumed that all the DBs are installed in corporations or institutions outside the bank A and the bank B. However, as a modification, some of the DBs may be installed also in at least either the bank A or the bank B. Furthermore, a single DB may be dispersedly installed in a plurality of corporations or institutions. For example, the securities holdings information DB 28 may be implemented by DBs of a plurality of securities companies, and the liabilities information DB 32 may be implemented by DBs of a plurality of banks or credit card companies.

Individual attribute information held in the individual attribute information source 16 includes information representing the assets, liabilities, and revenue or an individual. The assets cited in the embodiment belong to an individual, refer to economic values expected to produce revenue for the individual, and can also be regarded as property. Meanwhile, liabilities belong to an individual, refer to payment obligations that the individual owes to external third parties, and includes, for example, a borrowing. Among the DBs included in the individual attribute information source 16, the collateral information DB 20, the roadside land price information DB 22, the property information DB 24, the pension information DB 26, the securities holdings information DB 28, and the insurance information DB 30 hold information on the assets of an individual. In addition, the liabilities information DB 32 holds information on the liabilities of an individual. The revenue information DB 34 and the employment information DB 36 hold information on the revenue of an individual. Specific examples will be described below.

The collateral information DB 20 holds the assessed values of land and buildings offered as collateral for a loan (for example, assets on which a mortgage is placed). The collateral information DB 20 may be installed in, for example, a research company or real estate company. The roadside land price information DB 22 holds information on roadside land prices all across Japan. The roadside land price information DB 22 may be installed in, for example, a public institution (institution such as a tax office). The property information DB 24 holds information on the price, sales period and the like of property (land, buildings, and the like) to be purchased by an individual. The property information DB 24 may be installed in a real estate company or housing supplier.

The pension information DB 26 holds pension information of an individual. The pension information includes the amount of pension to be received by an individual in the future, including, for example, a defined contribution pension amount. The pension information DB 26 may be installed in a private or public pension organization, or a pension information service company. The securities holdings information DB 28 holds information on stocks, bonds, and the like held by an individual. The securities holdings information DB 28 may be installed in a plurality of securities companies. The insurance information DB 30 holds information on life insurance obtained by an individual, such as cash-value life insurance. The insurance information DB 30 may be installed in a plurality of insurance companies. The liabilities information DB 32 holds information on liabilities (for example, a car loan) for which an individual is responsible. The liabilities information DB 32 may be installed in a bank other than the banks A and B, a credit card company, and a credit information agency.

The revenue information DB 34 holds information representing the revenue of an individual (an annual revenue amount, an income amount, and the like). The revenue information DB 34 may be installed in a public institution such as a tax office. The employment information DB 36 holds information including, for example, the name of a company for which an individual works, working conditions (official position, and the like) at the company, and service years. The employment information DB 36 may be installed in a company for which an individual works, a credit information agency, or the like. The corporation information DB 38 holds information representing business conditions and financial situations of various corporations. The corporation information DB 38 may be installed in a credit information agency, an ICT service corporation, or the like.

Each DB included in the individual attribute information source 16 stores attribute information on each individual in association with an Individual Number assigned to each individual. Upon receiving a request to acquire individual attribute information from a predetermined external device via the communication network 18, each DB provides the device as the requesting source, with attribute information associated with an Individual Number specified as a key in the request.

The business support apparatus 14 is an information processing apparatus such as a server to be managed by an ICT service corporation. An ICT service corporation is, for example, a business operator such as a system integrator and an application service provider (ASP). The business support apparatus 14 provides the PC 12a and the PC 12b with a web page including information (hereinafter also referred to as “business support information”) for supporting a plurality of financial institutions (the bank A and the bank B in the embodiment) in business operations thereof. The function of a web server is publicly known. Accordingly, description thereof will be omitted.

Specifically, the business support apparatus 14 collects, from the individual attribute information source 16, a plurality of kinds of attribute information on, for example, assets, liabilities, and revenue of an individual to be analyzed as a candidate borrower from the bank A or the bank B (hereinafter also referred to as “individual to be analyzed”), by using the Individual Number of the individual to be analyzed. Then, based on the plurality of kinds of attribute information collected as above, the business support apparatus 14 provides the PC 12 of the bank A or the bank B with business support information for supporting the bank A or the bank B in executing its lending operations appropriate to the situation of each individual to be analyzed. Furthermore, the business support apparatus 14 provides a plurality of financial institutions (the bank A and the bank B in the embodiment) with such a business support information providing service as an ASP service.

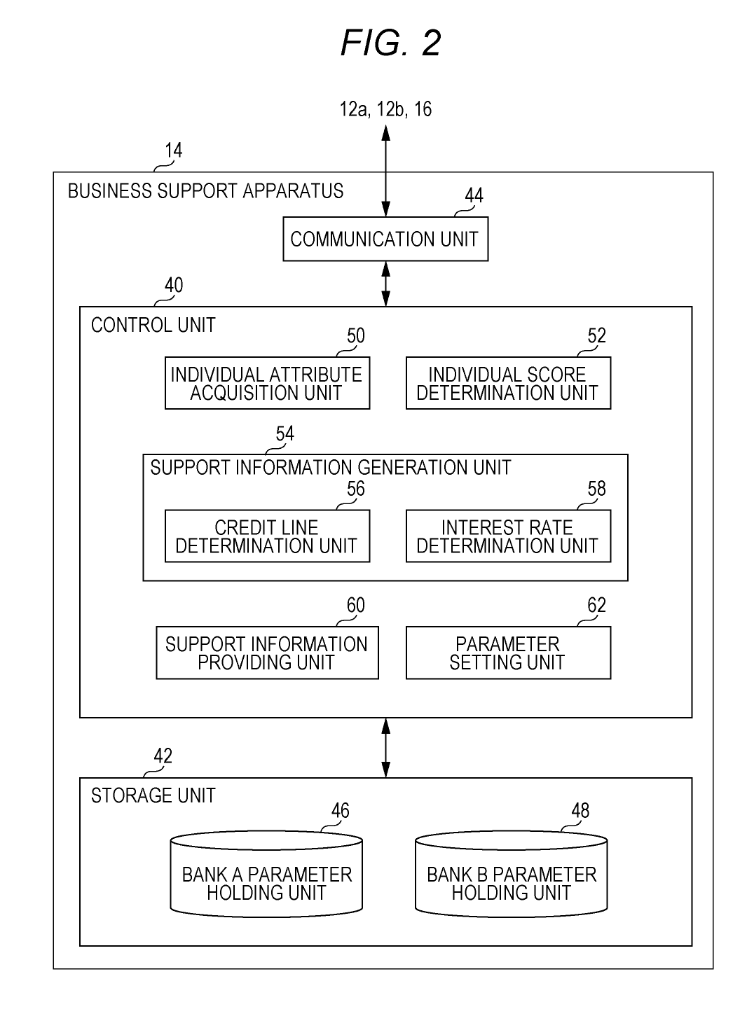

FIG. 2 is a block diagram showing a functional configuration of the business support apparatus 14 shown in FIG. 1. The business support apparatus 14 includes a control unit 40, a storage unit 42, and a communication unit 44. The control unit 40 executes various kinds of data processing such as collection processing of attribute information on an individual to be analyzed, and generation processing of business support information for the bank A and the bank B. The storage unit 42 is a storage area for storing data to be referred to or updated by the control unit 40. The communication unit 44 communicates with an external device in accordance with a publicly known communication protocol. The control unit 40 transmits and receives data to and from the PC 12a, the PC 12b, and each DB included in the individual attribute information source 16, via the communication unit 44.

In terms of hardware, each block shown in the block diagram of the present specification can be implemented by a CPU of a computer, elements including a memory, and a mechanical device. In terms of software, each block can be implemented by a computer program and the like. Here, the diagram depicts functional blocks to be implemented by cooperation therebetween. Therefore, it is to be understood by those skilled in the art that these functional blocks can be implemented in various forms according to combinations of hardware and software.

For example, a business support application including modules corresponding to respective blocks of the control unit 40 may be installed in the storage of the business support apparatus 14. The CPU of the business support apparatus 14 may fulfill the functions of these blocks by reading the modules corresponding to the respective blocks of the control unit 40 into a main memory and executing the modules. In addition, each functional block of the storage unit 42 may be implemented by a storage device storing data, such as storage and a memory of the business support apparatus 14.

The storage unit 42 includes a bank A parameter holding unit 46 and a bank B parameter holding unit 48. The bank A parameter holding unit 46 stores parameters predetermined by the bank A. The bank B parameter holding unit 48 stores parameters predetermined by the bank B independently of the parameters stored in the bank A parameter holding unit 46. The parameters stored in the bank A parameter holding unit 46 and the bank B parameter holding unit 48 are data for deriving scores of an individual to be analyzed according to respective details of assets information, liabilities information, and revenue information of the individual to be analyzed.

The parameters are information representing the degree to which the business support information (a credit line and a lending rate in the embodiment) is affected by each of a plurality of kinds of attribute information of an individual to be analyzed. The parameters can also be regarded as data for weighting. The parameters are not limited to numerical values, but may be a program or the like representing an algorithm for achieving a degree of influence or weighting according to attribute values. Hereinafter, a parameter for reflecting details represented by attribute information in a credit line is referred to as a credit line parameter, and a parameter for reflecting details represented by attribute information in an interest rate is referred to as an interest rate parameter.

As a parameter setting example, the credit line parameter and the interest rate parameter of each attribute information classified as the assets information may be determined in such a manner that the amount of assets represented by the assets information (for example, the total market value of stocks held) is positively correlated with a credit line, and at the same time, negatively correlated with an interest rate. In addition, the credit line parameter and the interest rate parameter of each attribute information classified as the liabilities information may be determined in such a manner that the amount of liabilities represented by the liabilities information (for example, an outstanding loan balance) is negatively correlated with a credit line, and at the same time, positively correlated with an interest rate. Furthermore, the credit line parameter and the interest rate parameter of each attribute information classified as the revenue information may be determined in such a manner that the amount of revenue represented by the revenue information (including the rank within a company) is positively correlated with a credit line, and at the same time, negatively correlated with an interest rate.

The bank A and the bank B each determine which information item to emphasize among the assets information, liabilities information, and revenue information. Each bank may set parameters for the respective information items in such a manner that a correlation coefficient of an information item to be emphasized, with respect to an interest rate and the like is larger than correlation coefficients of the other information items. Moreover, a different weight may be set for each of plural kinds of attribute information classified into the same assets information at the discretion of each bank. The same applies to the liabilities information and the revenue information. An example thereof will be described below.

For example, assume that the bank A emphasizes the total market value of stocks held, over a defined contribution pension amount. In this case, the bank A may set a credit line parameter for the defined contribution pension amount and a credit line parameter for the total market value of stocks held, in such a manner that a positive correlation between the total market value of stocks held and the credit line is stronger than a positive correlation between the defined contribution pension amount and the credit line. Additionally, in this case, the bank A may set an interest rate parameter for the defined contribution pension amount and an interest rate parameter for the total market value of stocks held, in such a manner that a negative correlation between the total market value of stocks held and the interest rate is stronger than a negative correlation between the defined contribution pension amount and the interest rate.

As another example, assume that the bank B emphasizes a defined contribution pension amount over the total market value of stocks held. In this case, the bank B may set a credit line parameter for the defined contribution pension amount and a credit line parameter for the total market value of stocks held, in such a manner that a positive correlation between the defined contribution pension amount and the credit line is stronger than a positive correlation between the total market value of stocks held and the credit line. Furthermore, in this case, the bank B may set an interest rate parameter for the defined contribution pension amount and an interest rate parameter for the total market value of stocks held, in such a manner that a negative correlation between the defined contribution pension amount and the interest rate is stronger than a negative correlation between the total market value of stocks held and the interest rate. In this manner, each of the plurality of financial institutions using the business support apparatus 14 sets any given values as the credit line parameters and the interest rate parameters.

The control unit 40 includes an individual attribute acquisition unit 50, an individual score determination unit 52, a support information generation unit 54, a support information providing unit 60, and a parameter setting unit 62. The individual attribute acquisition unit 50 transmits an attribute acquisition request specifying the Individual Number of an individual to be analyzed, as a search key, to a plurality of DBs included in the individual attribute information source 16. The individual attribute acquisition unit 50 acquires, from each DB included in the individual attribute information source 16, attribute information associated with the Individual Number as the search key, which is at least one of, for example, the assets information, liabilities information, and revenue information on the individual to be analyzed.

For example, the individual attribute acquisition unit 50 acquires the defined contribution pension amount of the individual to be analyzed from the pension information DB 26 installed in a public institution. Furthermore, the individual attribute acquisition unit 50 acquires the name and number of stocks held by the individual to be analyzed from the securities holdings information DB 28 installed in the securities companies. Moreover, the individual attribute acquisition unit 50 acquires liabilities held by the individual to be analyzed (for example, the outstanding balance and repayment status of a car loan) from the liabilities information DB 32 installed in a bank other than the banks A and B or a credit information agency.

The individual score determination unit 52 determines scores for an individual to be analyzed for determining details of business operations of a financial institution for the individual to be analyzed, based on a plurality of kinds of attribute information on the individual to be analyzed, acquired by the individual attribute acquisition unit 50. Specifically, the determination is performed based on a plurality of kinds of attribute information classified as the assets information, liabilities information, or revenue information. Specifically, the individual score determination unit 52 determines a score according to a plurality of kinds of attribute information on an individual to be analyzed and a parameter predetermined by the bank A or the bank B for each of the plurality of kinds of attribute information.

Scores for an individual to be analyzed in the embodiment are data for adjusting the value of a benchmark credit line and the value of a benchmark interest rate specified by the bank A or the bank B as an analysis requesting source. A score for adjusting a benchmark credit line is referred to as a credit line adjustment score. A score for adjusting a benchmark interest rate is reference to as an interest rate adjustment score. The credit line adjustment score can be regarded as adjustment data for reflecting, in a credit line, actual attribute information of an individual to be analyzed, by a weight represented by the credit line parameter. Similarly, the interest rate adjustment score can be regarded as adjustment data for reflecting, in an interest rate, actual attribute information of an individual to be analyzed by a weight represented by the interest rate parameter.

Here, a benchmark credit line and a benchmark interest rate are a standard credit line and a standard interest rate predetermined inside each of the bank A and the bank B. For example, a benchmark interest rate may be a conventional interest rate on loans (a variable interest rate, a 10-year fixed rate, and others) determined based on the short-term prime rate. In the embodiment, it is assumed that when requesting the business support apparatus 14 to perform analysis, a person in charge at each bank specifies a benchmark credit line and a benchmark interest rate. As a modification, the business support apparatus 14 may previously acquire a benchmark credit line and a benchmark interest rate from an apparatus of each bank, and store them in the storage unit 42 in advance.

The individual score determination unit 52 according to the embodiment determines, as credit line adjustment scores, a collateral information rate, a pension rate, a stock rate (regarding stocks held by an individual to be analyzed), an insurance rate (regarding insurance that the individual to be analyzed carries), a corporation rank rate (regarding a corporation for which the individual to be analyzed works), a service years rate, an official position rate, a liabilities rate, and a revenue rate. In addition, the individual score determination unit 52 determines, as interest rate adjustment scores, a collateral information rate, a pension rate, a stock rate, an insurance rate, a corporation rank rate, a service years rate, an official position rate, a liabilities rate, and a revenue rate.

For example, the individual score determination unit 52 calculates a collateral information rate as a credit line adjustment score, according to collateral information (land and buildings), age of a building, roadside land prices, and property information acquired from the individual attribute information source 16, and a credit line parameter associated with each attribute information at the bank A parameter holding unit 46 or the bank B parameter holding unit 48. Furthermore, the individual score determination unit 52 calculates a collateral information rate as an interest rate adjustment score, according to the collateral information (land and buildings), the age of a building, the roadside land prices, and the property information acquired from the individual attribute information source 16, and an interest rate parameter associated with each attribute information at the bank A parameter holding unit 46 or the bank B parameter holding unit 48.

The values of credit line parameters stored in the bank A parameter holding unit 46 and the bank B parameter holding unit 48 according to the embodiment are determined in such a manner that the larger the amount of assets (for example, the market value or assessed value of stocks) of an individual to be analyzed is, the higher a credit line is. Increasing a credit line can also be regarded as increasing the credit line by an increase from the predetermined standard benchmark credit line. Meanwhile, the values of interest rate parameters are determined in such a manner that the larger the amount of assets of the individual to be analyzed is, the lower an interest rate is. Decreasing an interest rate can also be regarded as increasing a discount from the predetermined standard benchmark interest rate.

Therefore, the individual score determination unit 52 determines, as credit line adjustment scores, a collateral information rate, a pension rate, a stock rate, and an insurance rate in such a manner that the larger the amount of assets of an individual to be analyzed is, the higher a credit line is. Moreover, the individual score determination unit 52 determines, as interest rate adjustment scores, a collateral information rate, a pension rate, a stock rate, and an insurance rate in such a manner that the larger the amount of assets of the individual to be analyzed is, the lower an interest rate is. The same applies to the relationship between the amount of revenue and a revenue rate. In this way, when the credit risk (in other words, bad debts risk) of a specific individual to be analyzed is relatively low, dynamic adjustments are made such that a credit line for the individual is relatively high, and an interest rate is relatively low.

In addition, the values of credit line parameters stored in the bank A parameter holding unit 46 and the bank B parameter holding unit 48 according to the embodiment are determined in such a manner that the larger the amount of liabilities (for example, the balance of borrowings) of an individual to be analyzed is, the lower a credit line is. Meanwhile, the values of interest rate parameters are determined in such a manner that the larger the amount of liabilities of the individual to be analyzed is, the higher an interest rate is.

Therefore, the individual score determination unit 52 determines, as credit line adjustment scores, a collateral information rate, a pension rate, a stock rate, and an insurance rate in such a manner that the larger the amount of liabilities of an individual to be analyzed is, the lower a credit line is. Moreover, the individual score determination unit 52 determines, as interest rate adjustment scores, a collateral information rate, a pension rate, a stock rate, and an insurance rate in such a manner that the larger the amount of liabilities of the individual to be analyzed is, the higher an interest rate is. In this way, when the credit risk of a specific individual to be analyzed is relatively high, dynamic adjustments are made such that a credit line for the individual is relatively low, and an interest rate is relatively high.

Based on the scores of an individual to be analyzed determined by the individual score determination unit 52, the support information generation unit 54 generates information for supporting a financial institution in its business operations for the individual to be analyzed. Specifically, the support information generation unit 54 determines a credit line for an individual to be analyzed by adjusting the benchmark credit line based on the credit line adjustment scores of the individual to be analyzed. Furthermore, the support information generation unit 54 determines an interest rate for the individual to be analyzed by adjusting the benchmark interest rate based on the interest rate adjustment scores of the individual to be analyzed. Then, the support information generation unit 54 generates business support information representing the credit line and the interest rate for the individual to be analyzed.

The support information generation unit 54 includes a credit line determination unit 56 and an interest rate determination unit 58. The credit line determination unit 56 determines a credit line for an individual to be analyzed by adjusting the benchmark credit line based on the credit line adjustment scores of the individual to be analyzed. The credit line determination unit 56 may enter, into a predetermined credit line calculation formula (function), the benchmark credit line, and a collateral information rate, a pension rate, a stock rate, a corporation rank rate, a service years rate, an official position rate, a liabilities rate, and a revenue rate as credit line adjustment scores, to obtain a credit line for an individual to be analyzed as a result of the calculation.

For example, the following calculation formula may be used:

Credit line for individual to be analyzed=benchmark credit line×collateral information rate×pension rate×stock rate×corporation rank rate×service years rate×official position rate×liabilities rate×revenue rate.

When using this calculation formula, the individual score determination unit 52 determines the score of each attribute information as follows. In order to obtain a credit line for an individual to be analyzed lower than the benchmark credit line, the individual score determination unit 52 determines the score of each attribute information in such a manner that the inequality “0<rate<1” holds. Meanwhile, in order to obtain a credit line for an individual to be analyzed equal to or higher than the benchmark credit line, the individual score determination unit 52 determines the score of each attribute information in such a manner that the inequality “1≤rate” holds. It should be noted that the score of each attribute information may be determined such that the result of multiplication of a plurality of kinds of credit line adjustment scores comes within the above-described ranges.

The interest rate determination unit 58 determines a lending rate for an individual to be analyzed by adjusting the benchmark interest rate based on the interest rate adjustment scores of the individual to be analyzed. The interest rate determination unit 58 may enter, into a predetermined interest rate calculation formula (function), the benchmark interest rate, and a collateral information rate, a pension rate, a stock rate, a corporation rank rate, a service years rate, an official position rate, a liabilities rate, and a revenue rate as interest rate adjustment scores, to obtain an interest rate for an individual to be analyzed as a result of the calculation.

For example, the following calculation formula may be used:

Interest rate for individual to be analyzed=benchmark interest rate×collateral information rate×pension rate×stock rate×corporation rank rate×service years rate×official position rate×liabilities rate×revenue rate.

When using this calculation formula, the individual score determination unit 52 determines the score of each attribute information as follows. In order to obtain an interest rate for an individual to be analyzed discounted from the benchmark interest rate, the individual score determination unit 52 determines the score of each attribute information in such a manner that the inequality “0<rate<1” holds. Meanwhile, in order to obtain an interest rate for an individual to be analyzed equal to or higher than the benchmark interest rate, the individual score determination unit 52 determines the score of each attribute information in such a manner that the inequality “1≤rate” holds. It should be noted that the score of each attribute information may be determined such that the result of multiplication of a plurality of kinds of interest rate adjustment scores comes within the above-described ranges.

The support information providing unit 60 transmits, to the PC 12a or the PC 12b as an analysis requesting source, business support information generated by the support information generation unit 54 including the credit line and the interest rate for an individual to be analyzed. Specifically, the support information providing unit 60 transmits data of a web page representing the business support information to the PC 12a or the PC 12b.

The parameter setting unit 62 transmits, to the PC 12a and the PC 12b, a web page for changing at least either credit line parameters or interest rate parameters, and causes the PC 12a and the PC 12b to display the web page. The parameter setting unit 62 receives, from the PC 12a and the PC 12b, the initial values or updated values of credit line parameters and interest rate parameters input to the web page. The parameter setting unit 62 reflects the received parameter values in score determination processing for an individual to be analyzed, to be performed by the individual score determination unit 52.

Specifically, the parameter setting unit 62 stores, in the bank A parameter holding unit 46, the values of the credit line parameters and the interest rate parameters received from the PC 12a. In other words, former parameter values stored in the bank A parameter holding unit 46 are updated with the latest values received from the PC 12a. Similarly, the parameter setting unit 62 stores, in the bank B parameter holding unit 48, the values of the credit line parameters and the interest rate parameters received from the PC 12b. In other words, former parameter values stored in the bank B parameter holding unit 48 are updated with the latest values received from the PC 12b. The updated values of the credit line parameters and the interest rate parameters are reflected in the scores of an individual to be analyzed, and are reflected in the credit line and the interest rate for the individual to be analyzed.

Operation based on the above-described configuration will be described. The person in charge of loans at the bank A activates a web browser of the PC 12a, logs in to a business support site provided by the business support apparatus 14, and selects a lending operation support menu. When the lending operation support menu is selected, the business support apparatus 14 transmits, to the PC 12a, a web page (referred to as “page for specifying an analysis object”) for inputting information on an individual to be analyzed, and causes the PC 12a to display the web page. The person in charge of loans at the bank A inputs, to the page for specifying an analysis object, the benchmark credit line and the benchmark interest rate in addition to the Individual Number of an individual to be analyzed, who is an individual regarded as a candidate borrower of a housing loan. Then, the person in charge of loans at the bank A inputs an operation to start analysis. The web browser of the PC 12a transmits, to the business support apparatus 14, an analysis request which is an HTTP request including the Individual Number of the individual to be analyzed, the benchmark credit line, and the benchmark interest rate.

Upon receiving the analysis request transmitted from the PC 12a, the individual attribute acquisition unit 50 of the business support apparatus 14 acquires a plurality of kinds of attribute information on the individual to be analyzed, from the plurality of DBs included in the individual attribute information source 16, by using the Individual Number specified in the request as a key. The individual score determination unit 52 of the business support apparatus 14 determines credit line adjustment scores (stock rate, liabilities rate, and the like) corresponding to the plurality of kinds of attribute information, according to credit line parameters which are parameters stored in the bank A parameter holding unit 46 and predetermined by the bank A as the analysis requesting source. Similarly, the individual score determination unit 52 determines interest rate adjustment scores corresponding to the plurality of kinds of attribute information, according to interest rate parameters predetermined by the bank A as the analysis requesting source.

The support information generation unit 54 of the business support apparatus 14 determines a credit line for the individual to be analyzed, based on the benchmark credit line specified in the analysis request and the credit line adjustment scores determined by the individual score determination unit 52. Furthermore, the support information generation unit 54 determines an interest rate on the loan to the individual to be analyzed, based on the benchmark interest rate specified in the analysis request and the interest rate adjustment scores determined by the individual score determination unit 52. Then, the support information generation unit 54 generates web page data of the business support information representing the credit line and the interest rate on the loan to the individual to be analyzed. The support information providing unit 60 transmits the web page data to the PC 12a, and causes the PC 12a to display the web page. The person in charge at the bank A develops a loan plan according to the credit line and the interest rate provided by the business support apparatus 14, and presents the loan plan to the individual to be analyzed.

As described above, according to the business support apparatus 14, it is possible to present, to a financial institution, an appropriate credit line and interest rate for each individual according to an asset holding situation, a situation of liabilities incurred, and a revenue situation for each individual as a debtor, and to support the financial institution as a creditor in its risk management and risk control. For example, stocks held by an individual are treated as a collateral factor of a debt without the necessity of selling the stocks, and are reflected in the credit line and the interest rate. In addition, achievements by an individual as a business person (for example, a rank in which the company is placed, service years, an official position, and working conditions), who is a party to a loan contract, are reflected in a credit line and an interest rate. Furthermore, it is possible to achieve calculation of the market value of collateral by calculating a collateral value in association with the roadside land price information of real estate.

In the case of having, for example, a large number of stocks, a large amount of savings in a savings-type insurance, and a large defined contribution pension amount, an individual as a debtor can enjoy the benefit of being capable of borrowing money of an amount exceeding the benchmark credit line, and also capable of easily obtaining a loan at an interest rate lower than the benchmark interest rate. Moreover, a financial institution as a creditor can enjoy the benefit of being capable of easily developing loan plans more appropriate to the situations of respective customers, and capable of enhancing competitiveness while controlling risks.

Also in the case where the person in charge of loans at the bank B activates a web browser of the PC 12b, and accesses a lending operation support site of the business support apparatus 14, the business support apparatus 14 performs similar processing according to an analysis request transmitted from the PC 12b. However, it is different in that the individual score determination unit 52 determines the scores of an individual to be analyzed with reference to credit line parameters and interest rate parameters which are parameters stored in the bank B parameter holding unit 48 and predetermined by the bank B as an analysis requesting source.

The person in charge of loans at the bank A (for example, an administrator having the authority to determine parameters) determines updated values of the credit line parameters and the interest rate parameters. The person in charge of loans at the bank A activates the web browser of the PC 12a, logs in to the lending operation support site provided by the business support apparatus 14, and selects a parameter setting menu. When the parameter setting menu is selected, the business support apparatus 14 transmits, to the PC 12a, a web page (referred to as “parameter setting page”) for inputting the updated values of the credit line parameters and the interest rate parameters, and causes the PC 12a to display the web page. The person in charge of loans inputs, to the parameter setting page, the updated values of the credit line parameters and the interest rate parameters. Then the person in charge of loans inputs an operation to reflect the setting values.

The web browser of the PC 12a transmits, to the business support apparatus 14, a parameter setting request which is an HTTP request including the updated values of the credit line parameters and the interest rate parameters. Upon receiving the parameter setting request transmitted from the PC 12a, the parameter setting unit 62 of the business support apparatus 14 stores, in the bank A parameter holding unit 46, the updated values of the credit line parameters and the interest rate parameters included in the request. The setting operation of the credit line parameters and the interest rate parameters of the bank B is also similar except that parameter values are stored in the bank B parameter holding unit 48.

As described above, the business support apparatus 14 according to the embodiment collectively provides business support services for a plurality of financial institutions, as ASP services. As a result, each financial institution can enjoy the benefit of business support services at a cost lower than that for establishing the business support apparatus 14 at its own expense. Furthermore, each financial institution can independently determine and set values as credit line parameters and interest rate parameters for determining the scores of an individual to be analyzed. In addition, the values can be changed any time. As a result, each financial institution can determine a credit line and an interest rate appropriate to its own risk management policy and business strategy, by using the business support apparatus 14.

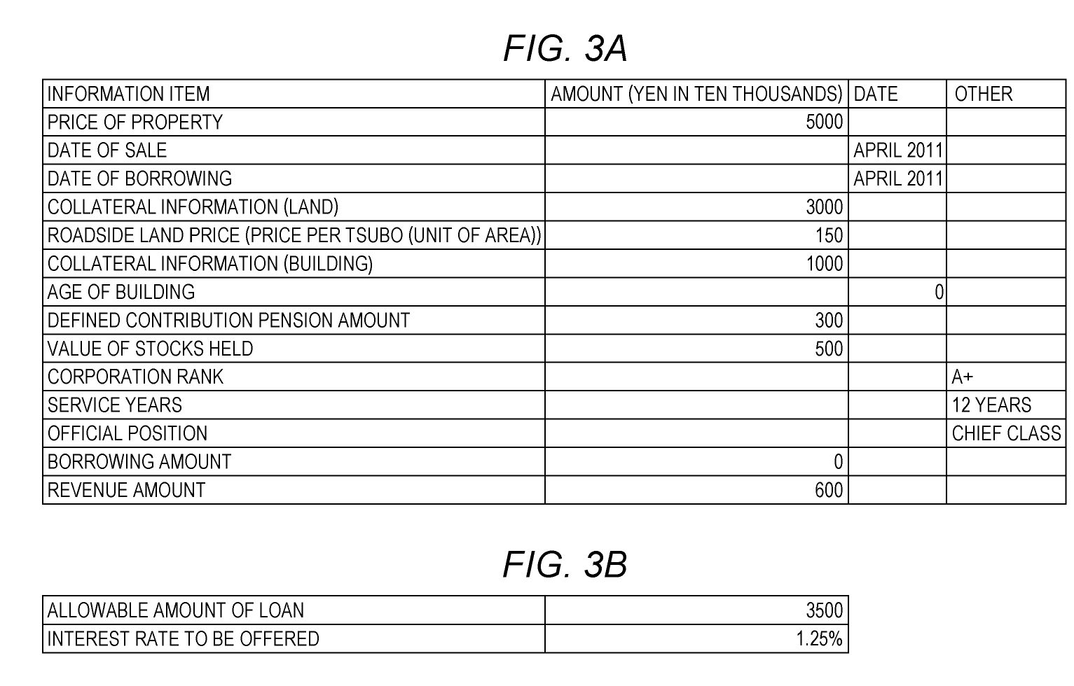

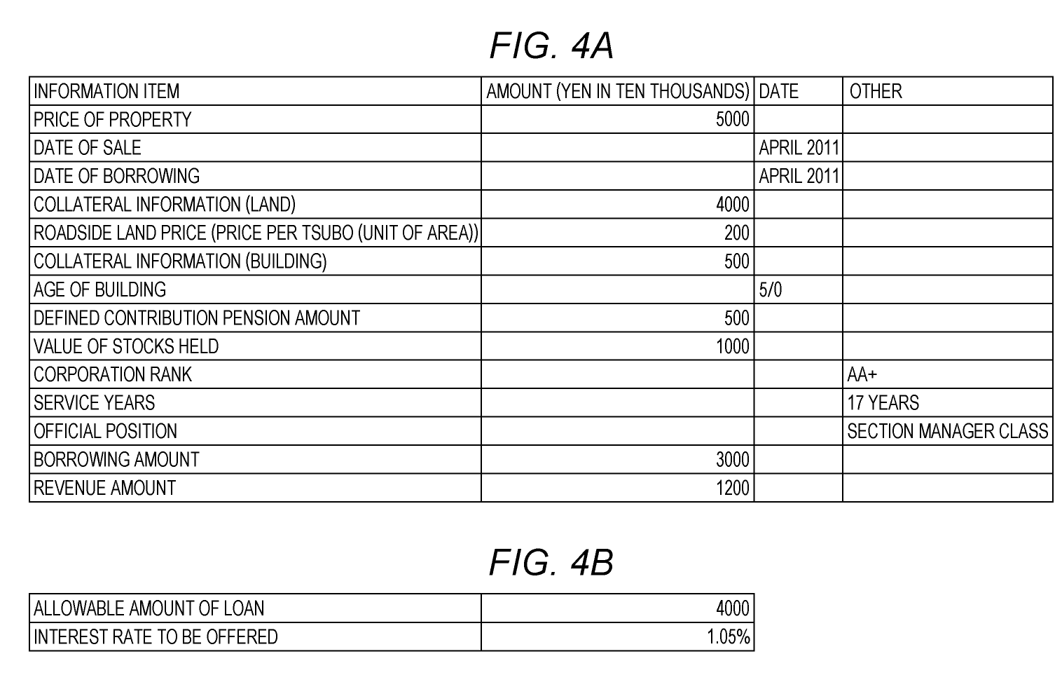

FIGS. 3A and 3B show an example of a loan to an individual. FIG. 3A shows individual attribute information at the time of an initial loan. FIG. 3B shows a credit line (upper row) and an interest rate (lower row) determined by the business support apparatus 14 based on the attribute information shown in FIG. 3A. FIGS. 4A and 4B show an example of a loan to the same individual as in FIGS. 3A and 3B. FIG. 4A shows attribute information of the individual at five years after the state shown in FIG. 3A. FIG. 4B shows a credit line (upper row) and an interest rate (lower row) determined by the business support apparatus 14 based on the attribute information shown in FIG. 4A.

Comparing the attribute information shown in FIG. 3A and the attribute information shown in FIG. 4A, it can be said that the amount of liabilities shown in FIG. 3A is smaller, and accordingly, the state shown in FIG. 3A involves a lower credit risk based on the liabilities. However, FIG. 4A shows larger assets (the values of collateral and stocks held, a defined contribution pension amount, and the like) and larger revenue (corporation rank, service years, an official position, and a revenue amount). Accordingly, it can be said that the state shown in FIG. 4A involves a lower credit risk based on the assets and revenue. The credit line and the interest rate calculated by the business support apparatus 14 comprehensively reflect the assets, liabilities, and revenue of an individual to be analyzed. In the examples, FIG. 4B shows a calculated credit line higher than that shown in FIG. 3B, and also shows a calculated interest rate lower than that shown in FIG. 3B.

For example, a person in charge at a financial institution can propose an additional loan to a customer at a lower interest rate in view of the results shown in FIG. 4B. Furthermore, in the case of providing a loan at a variable interest rate, it is possible to propose, to the customer, revision of an interest rate from the interest rate shown in FIG. 3B to the interest rate shown in FIG. 4B, in accordance with the current state of the customer. It should be noted that in the case where a financial institution using the business support apparatus 14 sets parameters with emphasis on a small amount of liabilities, it is also possible that FIG. 4B shows a calculated credit line lower than that shown in FIG. 3B, and also shows a calculated interest rate higher than that shown in FIG. 3B.

The present invention has been described above based on the embodiment. It is to be understood by those skilled in the art that the embodiment is illustrative, that various modifications can be made to the combination of each constituent element and each processing process, and that such modifications are also within the scope of the present invention. Modifications will be described below.

A first modification will be described. In the above-described embodiment, each DB in the individual attribute information source 16 electronically stores attribute information on an individual to be analyzed, and the business support apparatus 14 acquires the attribute information on the individual to be analyzed from each DB. As a modification, at least a part of attribute information on an individual to be analyzed may be declared orally or on paper from the individual to be analyzed to the bank A or the bank B. In addition, the declared attribute information may be input from the PC 12 to the business support apparatus 14. For example, in addition to the Individual Number of the individual to be analyzed, the benchmark credit line, and the benchmark interest rate, an analysis request including one or more kinds of attribute information (the name and number of stocks held, the official position and service years in a company, and others) declared by the individual to be analyzed may be input from the PC 12 to the business support apparatus 14. It is suitable for acquiring attribute information prohibited or restricted, by law, from being electronically acquired from an external DB, or attribute information requiring high confidentiality.

A second modification will be described. The business support apparatus 14 according to the above-described embodiment derives the credit line adjustment scores and the interest rate adjustment scores of an individual to be analyzed according to a plurality of kinds of attribute information of the individual to be analyzed. Then, based on the scores, the business support apparatus 14 generates information for supporting a financial institution in its lending operations for the individual to be analyzed (information representing a credit line and an interest rate for the individual to be analyzed), and provides the PC 12 with the generated information. As a modification, the business support apparatus 14 may determine scores for determining details of business operations of a financial institution for an individual to be analyzed, as scores other than the credit line adjustment scores and the interest rate adjustment scores. For example, the business support apparatus 14 may determine a score indicating the degree of importance of an individual to be analyzed for a financial institution. Alternatively, the business support apparatus 14 may determine scores indicating the degree of certainty of, for example, conclusion of a loan contract, purchase of securities, and conclusion of an insurance contract. Furthermore, the following configuration may be adopted. The support information generation unit 54 of the business support apparatus 14 generates business support information representing the scores themselves of the individual to be analyzed, determined by the individual score determination unit 52. Then, the support information providing unit 60 provides the PC 12 with the generated business support information.

A third modification will be described. Although not mentioned in the above-described embodiment, the business support apparatus 14 may collectively perform collection of attribute information on a plurality of individuals specified by the PC 12a or the PC 12b, and generation of business support information for supporting a financial institution in its business operations for the plurality of individuals. In other words, the business support apparatus 14 may perform generation of business support information on the plurality of individuals as batch processing. In addition, when generating business support information representing the scores themselves of an individual, as described in the second modification, the business support apparatus 14 may select, from among a plurality of individuals, an individual having a score (for example, a score indicating the number of stocks held) that satisfies selection conditions predetermined by a financial institution. Then, the business support apparatus 14 may generate business support information including scores and various kinds of attribute information relating to the selected individual, and provide the financial institution with the generated business support information.

A fourth modification will be described. The business support apparatus 14 according to the above-described embodiment collects attribute information on an individual to be analyzed from the plurality of DBs included in the individual attribute information source 16 by using the Individual Number assigned by a public institution to the individual to be analyzed. As a modification, based on the Individual Number assigned by the public institution to an individual to be analyzed, a first provisional number for identifying the individual to be analyzed at a financial institution, and a second provisional number for identifying the individual to be analyzed at an entity different from the financial institution may be determined in advance, and be associated with each other by a predetermined apparatus.

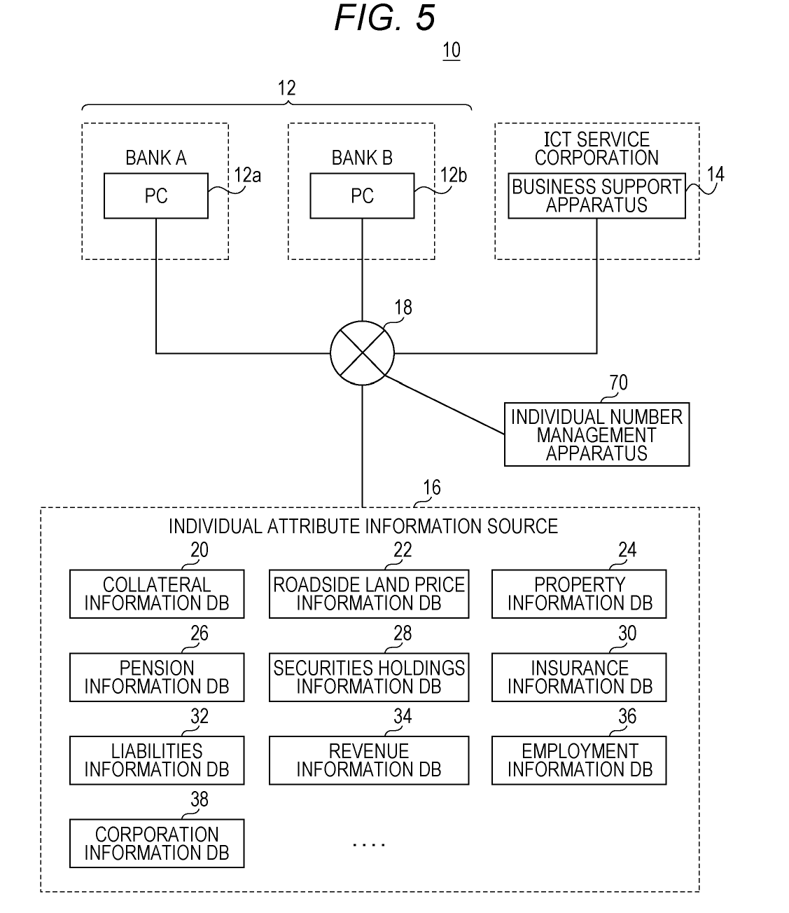

FIG. 5 shows the configuration of an information system according to the fourth modification. The information system 10 according to the fourth modification includes an Individual Number management apparatus 70 in addition to the configuration shown in FIG. 1. The business support apparatus 14 accesses the Individual Number management apparatus 70 via the communication network 18. The Individual Number management apparatus 70 corresponds to the Individual Number management apparatus proposed by the present applicant in “Japanese Patent Application No. 2013-216936 (JP 2015-79406 A).”

Specifically, the Individual Number management apparatus 70 receives a declaration of the Individual Number from an individual (not shown) (that is, an individual who can be an individual to be analyzed), and determines a first provisional number for identifying the individual at a financial institution (here, assumed to be the bank A) based on the Individual Number. The Individual Number management apparatus 70 may directly transmit the determined first provisional number along with identification information (name, address, and the like) of the individual to the apparatus of the bank A specified by the individual as a destination to which the first provisional number is to be provided. Alternatively, the determined first provisional number may be provided by the Individual Number management apparatus 70 to the device of the individual, and be declared by the individual to the bank A.

Furthermore, the Individual Number management apparatus 70 receives a declaration of the Individual Number from the same individual, and determines a second provisional number for identifying the individual at each corporation or each institution of the individual attribute information source 16, based on the Individual Number. The second provisional number may be transmitted to the individual attribute information source 16 in a manner similar to that of the first provisional number. It should be noted that actually, different numbers are determined as second provisional numbers for respective corporations and institutions that manage the DBs of the individual attribute information source 16. However, for the sake of simplicity, it will be described as a single second provisional number. Each DB of the individual attribute information source 16 stores attribute information on an individual to be analyzed in association with the second provisional number of the individual. Actually, the DBs of corporations and institutions different from one another may store attribute information on an individual to be analyzed in association with second provisional numbers different from one another.

Here, the Individual Number, the first provisional number, and the second provisional number of an individual are IDs different from one another in system, length, content, and the like. In addition, it is preferable that the first provisional number and the second provisional number are both determined as IDs from which the original Individual Number cannot be easily inferred. The first provisional number of an individual to be analyzed may be treated as equivalent to the Individual Number of the individual to be analyzed in the bank A. In addition, the second provisional number of an individual to be analyzed may be treated as equivalent to the Individual Number of the individual to be analyzed in the corporations or institutions of the individual attribute information source 16. However, since the first provisional number is different from the Individual Number, number management costs in the bank A can be reduced. Furthermore, if, by any chance, the first provisional number is leaked, the impact thereof is thus limited. The same applies to the second provisional number.

The Individual Number management apparatus 70 stores the Individual Number, the first provisional number, and the second provisional number of an individual in association with one another (see, for example, FIG. 3 of JP 2015-79406 A). Upon receiving a search request specifying a first provisional number, the Individual Number management apparatus 70 transmits information representing a second provisional number associated with the first provisional number to an apparatus as the source of the request

The PC 12a according to the fourth modification transmits, to the business support apparatus 14, an analysis request including the first provisional number of an individual to be analyzed, a benchmark credit line, and a benchmark interest rate. Upon receiving the analysis request, the individual attribute acquisition unit 50 of the business support apparatus 14 transmits, to the Individual Number management apparatus 70, a search request specifying the first provisional number specified in the analysis request, and acquires, from the Individual Number management apparatus 70, a second provisional number managed in association with the first provisional number. The individual attribute acquisition unit 50 transmits an attribute acquisition request specifying the second provisional number, as a key, to a plurality of DBs included in the individual attribute information source 16, and acquires attribute information managed in association with the second provisional number from each DB. Actually, the individual attribute acquisition unit 50 may acquire, from the Individual Number management apparatus 70, a plurality of kinds of second provisional numbers together with information of DBs to which the respective second provisional numbers have been provided. Then, the individual attribute acquisition unit 50 may transmit search requests specifying the different second provisional numbers to the different DBs.

According to an aspect of the fourth modification, the Individual Number management apparatus 70 intensively and collectively manages the Individual Numbers that require advanced security and high confidentiality. Financial institutions and the individual attribute information source 16 manage information by using, as keys, the first provisional numbers or second provisional numbers different from the Individual Numbers. A risk of leakage of the Individual Numbers can be reduced accordingly. In addition, it is possible to reduce a burden on each corporation or institution in managing the Individual Numbers.

A fifth modification will be described. In the above-described embodiment, the business support apparatus 14 collectively provides business support services for a plurality of financial institutions as ASP services. As a modification, the business support apparatus 14 may be constructed as an apparatus that generates business support information for a single financial institution or a small number of financial institutions within the same business group. For example, the business support apparatus 14 including the bank A parameter holding unit 46, but not including the bank B parameter holding unit 48, may be constructed in the bank A. In addition, separately from the above, the business support apparatus 14 including the bank B parameter holding unit 48, but not including the bank A parameter holding unit 46, may be constructed in the bank B.

A sixth modification will be described. In the above-described embodiment, individuals are to be analyzed by the business support apparatus 14. Meanwhile, subjects to be analyzed are not limited to individuals in the present modification. For example, subjects to be analyzed by the business support apparatus 14 may be corporate bodies (corporation, organization, and the like). In other words, borrowers from a financial institution supported by the business support apparatus 14 are not limited to individuals, but may be corporate bodies. In this case, each DB of the individual attribute information source 16 may store attribute information of a corporate body to be analyzed in association with a Corporate Number which is a unique number of the corporate body assigned by a public institution to the corporate body. The PC 12 may transmit an analysis request specifying the Corporate Number of the corporate body to be analyzed to the business support apparatus 14. The business support apparatus 14 may collect attribute information of the corporate body to be analyzed from each DB of the individual attribute information source 16 by using the Corporate Number as a key. Then, the business support apparatus 14 may generate information (for example, information of a credit line and an interest rate on a loan to the corporate body) for supporting the financial institution in its business operations for the corporate body, and provide the PC 12 with the generated information.

A seventh modification will be described. Those used for collecting various kinds of attribute information of respective customers from an external device are not limited to the Individual Numbers. For example, a credit card number may be used. In addition, it is also possible to use an ID for identifying a user in coordination among a plurality of business operators through Security Assertion Markup Language (SAML), OpenID, or the like. Each DB included in the individual attribute information source 16 may store attribute information on an individual in association with a credit card number of the individual or the above-described ID for identifying a user, instead of storing the attribute information in association with the Individual Number assigned to the individual.

The individual attribute acquisition unit 50 of the business support apparatus 14 may directly collect a plurality of kinds of attribute information on an individual to be analyzed from each DB of the individual attribute information source 16 by using, as a key, an ID (hereinafter referred to as “personal ID”) for identifying the individual to be analyzed including, for example, an Individual Number, a credit card number, and the above-described ID for identifying a user. In addition, the individual attribute acquisition unit 50 may acquire attribute information (also referred to as “claim”) on an individual to be analyzed from the individual attribute information source 16 by using OpenID Connect, with the individual attribute information source 16 as an OpenID provider and the business support apparatus 14 as a Relying Party.

Here, how to specify the individual attribute information source 16, as a source of attribute information to be collected, from among a plurality of the individual attribute information sources 16 becomes a problem in the case of collecting a plurality of kinds of attribute information from the individual attribute information sources 16.

In this regard, in the case where the business support apparatus 14 directly collects attribute information from the individual attribute information source 16, the business support apparatus 14 may include information, set in advance, for identifying one or more individual attribute information sources 16 provided by business operators having a partnership with the bank A or the bank B shown in FIG. 5, among the individual attribute information sources 16 provided by various business operators. The information may be set by, for example, a person in charge of loans at the bank A or the bank B. Alternatively, a person in charge of loans at the bank A or the bank B, or the like (hereinafter referred to as “person in charge of business operations”) may obtain by, for example, e-mail from an individual to be analyzed, first information (for example, attribute information name) for identifying attribute information of an individual to be analyzed, and second information for identifying the individual attribute information source 16 storing the attribute information. The person in charge of business operations may set, in the business support apparatus 14, a plurality of pieces of collection support information each of which is formed of a pair of the first information and the second information.

Alternatively, in the case where the business support apparatus 14 collects attribute information by using OpenID Connect, the business support apparatus 14 may specify a plurality of the individual attribute information sources 16 by aggregated claims or distributed claims. For example, in the sequence for specifying an OpenID Provider, the business support apparatus 14 may cause a terminal, which is to be used by an individual to be analyzed, to display a screen that allows an input of a plurality of pieces of collection support information each of which is formed of a pair of the above-described first information and the above-described second information. The above-described sequence for specifying an OpenID Provider may be as follows: (1) an Initiate is transmitted from the terminal of the individual to be analyzed to the business support apparatus 14 (Relying Party), and (2) an authorization request is transmitted from the business support apparatus 14 to the terminal of the individual to be analyzed.

The business support apparatus 14 may acquire one or more pieces of collection support information input to the above-described screen from the terminal of an individual to be analyzed. Based on the one or more pieces of collection support information, the business support apparatus 14 may set request parameters “_claim names” (a parameter including a claim name and an identifier of an acquisition source) and “_claim_sources” (a parameter including an identifier of an acquisition source and a value). According to the above-described request parameters, the business support apparatus 14 may execute a sequence of OpenID Connect, with any one of the plurality of individual attribute information sources 16 as an OpenID Provider.

An eighth modification will be described. Although not mentioned in the above-described embodiment, when attribute information of customers and the like is stored in one place, a risk of information leakage becomes relatively high. Therefore, in order to reduce the risk, a piece of attribute information may be divided into pieces of fragment information such that each of a plurality of servers stores fragment information of the piece of attribute information. Alternatively, a piece of attribute information may be divided after being encrypted. For example, fragment information generated by dividing liabilities information of an individual may be held in each of a plurality of servers physically included in the liabilities information DB 32.

When using attribute information of an individual, the business support apparatus 14 may collect fragment information from a plurality of servers to restore the original attribute information. In addition, the business support apparatus 14 (or another screen providing apparatus) may restore attribute information, only in the case where either an attribute information provider (for example, a customer as a debtor) or an attribute information keeper (for example, a financial institution) performs procedures on a screen after normally logging in to a system. Alternatively, the business support apparatus 14 (or another screen providing apparatus) may execute processing such as reference and updating of attribute information. Upon completion of processing relating to attribute information, the business support apparatus 14 (or another screen providing apparatus) may divide the attribute information, and store the divided attribute information as fragment information dispersedly in a plurality of servers.

For example, techniques disclosed in the following documents may be applied to dividing and restoring attribute information. Descriptions of the following documents are incorporated herein by reference:

JP 2013-020312 A, JP 2013-020313 A, JP 2013-020314 A, JP 2013-120515 A, JP 2013-120516 A, WO 2013/65133 A, and WO 2013/80290 A.

Any combination of the above-described embodiment and modifications is also useful as an embodiment of the present invention. A new embodiment resulting from the combination has respective effects of the combined embodiment and modifications. In addition, it is also to be understood by those skilled in the art that a function to be fulfilled by each constituent element recited in the claims is implemented by each of the constituent elements alone or cooperation therebetween set forth in the embodiment and the modifications.

The present invention can be applied to an apparatus for supporting a financial institution in its business operations.

1. An information processing apparatus that supports a financial institution in business operations thereof, comprising:
an acquisition unit configured to acquire assets information representing assets held by a subject to be analyzed, outside the financial institution;
a score determination unit configured to determine a score of the subject to be analyzed, for determining details of business operations of the financial institution for the subject to be analyzed, based on the assets information acquired by the acquisition unit; and
a support information generation unit configured to generate information for supporting the financial institution in business operations thereof for the subject to be analyzed, based on the score of the subject to be analyzed, determined by the score determination unit.

2. The information processing apparatus according to claim 1, wherein
the support information generation unit generates information representing an interest rate on a loan to the subject to be analyzed, provided by the financial institution, the interest rate being adjusted based on the score of the subject to be analyzed, determined by the score determination unit.

3. The information processing apparatus according to claim 2, wherein
the score determination unit determines the score of the subject to be analyzed such that as the assets held by the subject to be analyzed, outside the financial institution increase, the interest rate decreases.

4. The information processing apparatus according to claim 1, wherein
the assets information of the subject to be analyzed is managed in an apparatus of an entity different from the financial institution in association with a unique number assigned by a public institution to the subject to be analyzed, and
the acquisition unit accesses the apparatus of the different entity via a communication network, and acquires the assets information of the subject to be analyzed, by using, as a key, the unique number of the subject to be analyzed.

5. The information processing apparatus according to claim 1, wherein
a first provisional number for identifying the subject to be analyzed in the financial institution and a second provisional number for identifying the subject to be analyzed in an entity different from the financial institution are determined in advance based on a unique number assigned by a public institution to the subject to be analyzed, the first provisional number and the second provisional number being associated with each other by a predetermined apparatus,
the assets information of the subject to be analyzed is managed in an apparatus of the entity different from the financial institution in association with the second provisional number, and
the acquisition unit accesses the apparatus of the different entity via a communication network, and acquires the assets information of the subject to be analyzed by using, as a key, the second provisional number associated with the first provisional number of the subject to be analyzed.

6. The information processing apparatus according to claim 1, wherein
the acquisition unit further acquires liabilities information representing liabilities incurred by the subject to be analyzed, outside the financial institution, and
the score determination unit determines the score of the subject to be analyzed, based on each of the assets information and the liabilities information acquired by the acquisition unit.

7. The information processing apparatus according to claim 1, further comprising:
a parameter setting unit configured to receive, from an apparatus of the financial institution, a parameter for deriving a score according to details of the assets represented by the assets information, and reflect the received parameter in score determination processing to be performed by the score determination unit.

8. An information processing apparatus that supports a plurality of financial institutions in business operations thereof, comprising:
an acquisition unit configured to acquire assets information representing assets held by a first subject that is a subject to be analyzed in a first financial institution, the assets being held outside the first financial institution;
a score determination unit configured to determine a score of the first subject for determining details of business operations of the first financial institution for the first subject, based on the assets information of the first subject acquired by the acquisition unit and a parameter predetermined by the first financial institution; and
a support information generation unit configured to generate information for supporting the first financial institution in business operations thereof for the first subject, based on the score of the first subject determined by the score determination unit,
wherein the acquisition unit further acquires assets information representing assets held by a second subject that is a subject to be analyzed in a second financial institution, the assets being held outside the second financial institution,
the score determination unit further determines a score of the second subject for determining details of business operations of the second financial institution for the second subject, based on the assets information of the second subject acquired by the acquisition unit and a parameter predetermined by the second financial institution, and
the support information generation unit further generates information for supporting the second financial institution in business operations thereof for the second subject, based on the score of the second subject determined by the score determination unit.

9. An information processing method to be performed by an apparatus that supports a financial institution in business operations thereof, comprising:
a step of acquiring assets information representing assets held by a subject to be analyzed, outside the financial institution;
a step of determining a score of the subject to be analyzed, for determining details of business operations of the financial institution for the subject to be analyzed, based on the acquired assets information; and
a step of generating information for supporting the financial institution in business operations thereof for the subject to be analyzed, based on the determined score of the subject to be analyzed.

10. A computer program for causing an apparatus that supports a financial institution in business operations thereof to realize:
a function of acquiring assets information representing assets held by a subject to be analyzed, outside the financial institution;
a function of determining a score of the subject to be analyzed, for determining details of business operations of the financial institution for the subject to be analyzed, based on the acquired assets information; and
a function of generating information for supporting the financial institution in business operations thereof for the subject to be analyzed, based on the determined score of the subject to be analyzed.

11. The information processing apparatus according to claim 2, wherein
the assets information of the subject to be analyzed is managed in an apparatus of an entity different from the financial institution in association with a unique number assigned by a public institution to the subject to be analyzed, and
the acquisition unit accesses the apparatus of the different entity via a communication network, and acquires the assets information of the subject to be analyzed, by using, as a key, the unique number of the subject to be analyzed.

12. The information processing apparatus according to claim 3, wherein
the assets information of the subject to be analyzed is managed in an apparatus of an entity different from the financial institution in association with a unique number assigned by a public institution to the subject to be analyzed, and
the acquisition unit accesses the apparatus of the different entity via a communication network, and acquires the assets information of the subject to be analyzed, by using, as a key, the unique number of the subject to be analyzed.

13. The information processing apparatus according to claim 2, wherein
a first provisional number for identifying the subject to be analyzed in the financial institution and a second provisional number for identifying the subject to be analyzed in an entity different from the financial institution are determined in advance based on a unique number assigned by a public institution to the subject to be analyzed, the first provisional number and the second provisional number being associated with each other by a predetermined apparatus,
the assets information of the subject to be analyzed is managed in an apparatus of the entity different from the financial institution in association with the second provisional number, and
the acquisition unit accesses the apparatus of the different entity via a communication network, and acquires the assets information of the subject to be analyzed by using, as a key, the second provisional number associated with the first provisional number of the subject to be analyzed.

14. The information processing apparatus according to claim 3, wherein
a first provisional number for identifying the subject to be analyzed in the financial institution and a second provisional number for identifying the subject to be analyzed in an entity different from the financial institution are determined in advance based on a unique number assigned by a public institution to the subject to be analyzed, the first provisional number and the second provisional number being associated with each other by a predetermined apparatus,
the assets information of the subject to be analyzed is managed in an apparatus of the entity different from the financial institution in association with the second provisional number, and
the acquisition unit accesses the apparatus of the different entity via a communication network, and acquires the assets information of the subject to be analyzed by using, as a key, the second provisional number associated with the first provisional number of the subject to be analyzed.

15. The information processing apparatus according claim 2, wherein
the acquisition unit further acquires liabilities information representing liabilities incurred by the subject to be analyzed, outside the financial institution, and
the score determination unit determines the score of the subject to be analyzed, based on each of the assets information and the liabilities information acquired by the acquisition unit.

16. The information processing apparatus according claim 3, wherein
the acquisition unit further acquires liabilities information representing liabilities incurred by the subject to be analyzed, outside the financial institution, and
the score determination unit determines the score of the subject to be analyzed, based on each of the assets information and the liabilities information acquired by the acquisition unit.

17. The information processing apparatus according claim 4, wherein
the acquisition unit further acquires liabilities information representing liabilities incurred by the subject to be analyzed, outside the financial institution, and
the score determination unit determines the score of the subject to be analyzed, based on each of the assets information and the liabilities information acquired by the acquisition unit.

18. The information processing apparatus according to claim 2, further comprising:
a parameter setting unit configured to receive, from an apparatus of the financial institution, a parameter for deriving a score according to details of the assets represented by the assets information, and reflect the received parameter in score determination processing to be performed by the score determination unit.

19. The information processing apparatus according to claim 3, further comprising:
a parameter setting unit configured to receive, from an apparatus of the financial institution, a parameter for deriving a score according to details of the assets represented by the assets information, and reflect the received parameter in score determination processing to be performed by the score determination unit.

20. The information processing apparatus according to claim 4, further comprising:
a parameter setting unit configured to receive, from an apparatus of the financial institution, a parameter for deriving a score according to details of the assets represented by the assets information, and reflect the received parameter in score determination processing to be performed by the score determination unit.
